(19) United States
(12) Patent Application Publication
(10) Pub. No.: US 2005/0197978 A1
(43) Pub. Date: Sep. 8, 2005

(54) Speculative pool

(76) Inventors: David M. Anderson, Fort Collins, CO (US); Tyson R. McGuffin, Fort Collins, CO (US); Thomas W. Chen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/761,478

(22) Filed: Jan. 21, 2004

(51) Int. Cl. G06N 3/00

(52) U.S. Cl. 706/13

(57) ABSTRACT

Systems and methods are provided for selecting a value set associated with a set of parameters. A system is disclosed that includes a real cost function that generates a plurality of real costs corresponding to a plurality of real chromosomes. A real pool maintains the plurality of real chromosomes and associated real costs. An incremental cost function generates a plurality of speculative costs corresponding to a plurality of speculative chromosomes. A speculative pool maintains the plurality of speculative chromosomes and associated speculative costs.

### CROSS REFERENCE TO RELATED APPLICATIONS

This application is related to the following commonly assigned co-pending patent applications entitled: “SPECULATION COUNT IN A GENETIC ALGORITHM,” Attorney Docket No. 200309413-1; “POSTPONING VALIDATION OF SPECULATIVE CHROMOSOMES,” Attorney Docket No. 200309415-1; “SYSTEMS AND METHODS FOR SELECTING A VALUE SET,” Attorney Docket No. 200309416-1, all of which are filed contemporaneously herewith and are incorporated herein by reference.

### BACKGROUND

Genetic algorithms are application technologies inspired by mechanisms of inheritance and evolution of living things. In the evolution of living things, genomic changes like crossovers of chromosomes and mutations of genes can occur when new individuals (children) are born from old individuals (parents). In a genetic algorithm, a candidate of a solution to an optimization problem is represented as a data structure, referred to as a chromosome. The data structure represents a plurality of variables or bits referred to as genes. Typically, a plurality of n-bit parent chromosomes are generated and assigned a cost based on evaluation of a cost function. Chromosomes with lower costs are selected for generating children. Child chromosomes are generated through a process of crossover and mutation of parent chromosomes to produce new child chromosomes. Child chromosomes with lower costs replace members of the population with higher costs to assure evolutionary advance to an optimal solution.

### SUMMARY

Systems and methods for selecting a value set associated with a set of parameters are disclosed. One embodiment of the present invention relates to a system comprising a real cost function that generates real costs for each of a plurality of value sets represented as a plurality of real chromosomes. A real pool maintains the plurality of real chromosomes and associated real costs. An incremental cost function generates a plurality of speculative costs corresponding to a plurality of value set variations of at least one of the plurality of real chromosomes. The plurality of value set variations are represented as a plurality of speculative chromosomes. A speculative pool maintains the plurality of speculative chromosomes and associated speculative costs.

In another embodiment, a computer-readable medium having stored thereon a data structure is disclosed. The data structure includes speculative chromosomes that represent value set variations of at least one parent chromosome that represents a value set. The at least one parent chromosome comprises at least one of a real chromosome and a speculative chromosome. The data structure includes speculative costs associated with corresponding speculative chromosomes. The speculative cost of a given speculative chromosome is determined based on a cost of the at least one parent chromosome and a value set variation between the speculative chromosome and the at least one parent chromosome. The data structure also includes speculative generation counts associated with each speculative chromosome. The speculation generation count is based on a level of speculation from a real chromosome.

In yet another embodiment, a method for selecting a value set associated with a set of parameters is disclosed. The method may comprise generating real costs for each of a plurality of first value sets represented as a plurality of real chromosomes. The plurality of real chromosomes and associated real costs may be stored in a real pool. Speculative costs may be generated for each of a plurality of second value sets represented as a plurality of speculative chromosomes. The speculative chromosomes can represent value set variations of the first value sets. The plurality of speculative chromosomes and associated speculative costs may be stored in a speculative pool.

### BRIEF DESCRIPTION OF THE DRAWINGS

FIG. 1 illustrates a block diagram of an embodiment of a system for selecting a value set associated with a set of parameters.

FIG. 2 illustrates a schematic diagram of an embodiment of a speculative pool.

FIG. 3 illustrates a schematic diagram of an embodiment of a real pool.

FIG. 4 illustrates a block diagram of an alternate embodiment of a system for selecting a value set associated with a set of parameters.

FIG. 5 is an embodiment of a graph that illustrates a relationship between an exemplary cost function and a plurality of incremental cost functions.

FIG. 6 illustrates a block diagram of an embodiment of a system for optimizing a circuit design.

FIG. 7 is a flow diagram that illustrates an embodiment of a methodology for selecting a value set associated with a set of parameters.

FIG. 8 is a flow diagram that illustrates another embodiment of a methodology for selecting a value set associated with a set of parameters.

FIG. 9 illustrates an embodiment of a computer system.

### DETAILED DESCRIPTION

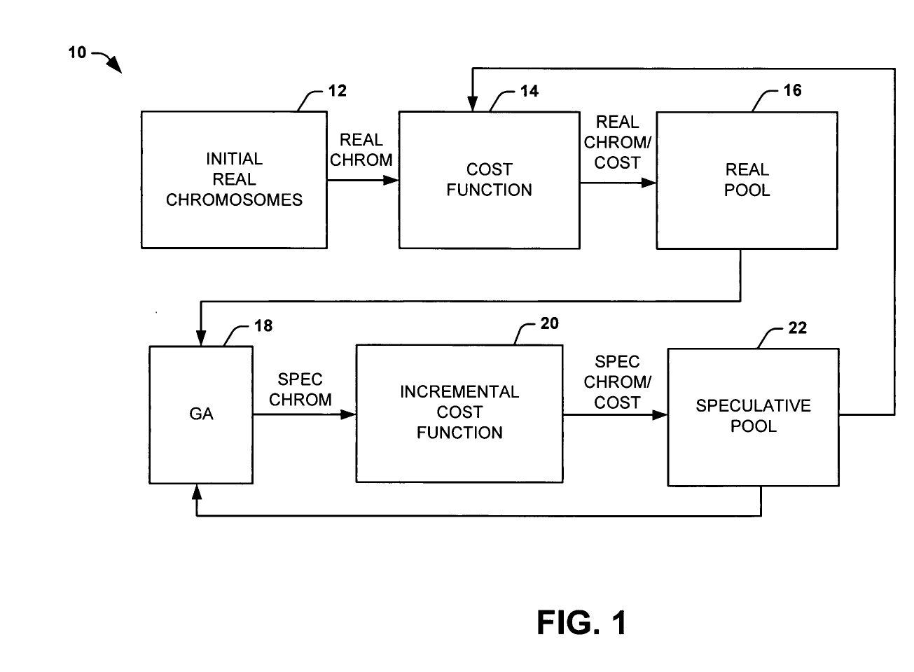

FIG. 1 illustrates a system 10 for selecting a value set associated with a set of parameters. The system 10 can be a computer, a server or some other computer readable medium that can execute computer readable instructions. For example, the components of the system 10 can be computer executable components, such as can be stored in a desired storage medium (e.g., random access memory, a hard disk drive, CD ROM, and the like), computer executable components running on a computer or design tool. The set of parameters can define properties or attributes associated with an optimizable function or structure.

An optimizable function or structure refers to a solution that can be improved with adjustment of values associated with one or more parameters to achieve a desirable acceptable solution. The optimizable function or structure can be, for example, a circuit design, a mathematical problem or some other optimizable function or structure. Each value set associated with the set of parameters represents a potential solution to the optimizable function or structure. The system 10 selects a value set based on a desired fitness value or desired minimal cost. A change in value in any one of the parameters defines a new value set. Each value set is represented by a chromosome, with each parameter representing a gene in the chromosome.

The terms “real” and “speculative” are used herein to distinguish the terms modified thereby. For example, a real cost function is a basis cost function that generates a cost (e.g., real cost) associated with a value set. A speculative cost function provides a cost (e.g., speculative cost) that is an approximate of the cost (e.g., real cost) that would be generated by the basis cost function. A speculative cost function can be arbitrary or predetermined cost function that can be generated based on a real cost function value. The employment of a speculative cost function facilitates convergence of a desired solution by trading speed for accuracy.

A real chromosome represents a value set employed by a real cost function 14 (e.g., multi-variable cost function) to generate a real cost for a given value set. An initial set of real chromosomes 12 are provided to the real cost function 14 to generate real costs associated with each of the real chromosomes 12. The real chromosomes 12 and associated real costs are stored in a real pool 16. The real pool is a data structure (e.g., a table, a list, a data base, etc.) that maintains the real chromosomes and associated real costs, or references (e.g., pointers) to the real chromosomes in memory. The real chromosomes 12 can be ranked or ordered in the real pool 16 based on minimum real costs associated with respective real chromosomes 12. The real pool 16 can include a set number of real chromosomes 12, such that real chromosomes 12 having real costs exceeding a predetermined minimum cost level are discarded from the real pool 16.

The real chromosomes 12 from the real pool 16 are employed by a genetic algorithm 18 to generate children chromosomes associated with parent chromosomes selected from the real chromosomes 12. The children chromosomes are generated through a process of crossover and mutation of parent chromosomes. The children chromosomes generated by the genetic algorithm 20 are referred to as speculative chromosomes. The children chromosomes derived from parents of the real chromosomes are a first generation of speculative chromosomes. A speculative chromosome is a value set employed by an incremental cost function 20 to generate speculative costs associated with value set variations of real chromosomes. The incremental cost function 20 provides an approximate or speculative cost for a given value set represented as a speculative chromosome. This enables an increase in speed of the system 10 since computing speculative costs, based on an approximation of the real costs, tends to be faster than computing the real costs employing the real cost function 14.

The speculative chromosomes and their associated speculative costs are stored and maintained in a speculative pool 22. The speculative pool is a data structure (e.g., a table, a list, a data base, etc.) that maintains the speculative chromosomes and associated speculative costs, or references (e.g., pointers) to the speculative chromosomes in memory. The speculative chromosomes can be ranked or ordered in the speculative pool 22 based on minimum speculative costs. The speculative pool can include a set number of speculative chromosomes. Additionally, speculative chromosomes having speculative costs exceeding a predetermined minimum cost level can be discarded from the speculative pool 22. It is to be appreciated that the real pool 16 and the speculative pool 22 can include chromosome references or pointers to the value sets associated with a real or speculative chromosome stored in memory.

The genetic algorithm 20 can generate one or more generations of speculative chromosomes based on selecting parent chromosomes from the speculative pool 22. Alternatively, parents can be selected from the speculative pool 22 and the real pool 16, such that one parent is selected from the speculative pool 22 and another parent is selected from the real pool 16 for a given child chromosome. Speculative costs can be approximated for speculative chromosomes in subsequent generations, via the incremental cost function 20, similar to the approximation performed for first generation speculative chromosomes.

For example, the incremental cost function 20 can employ two parent chromosomes selected from the real pool 16, a first generation speculative child chromosome generated from the selected real chromosome parents, and the cost-evaluation of the real parents to approximate a speculative cost for a given first generation speculative child chromosome. The incremental cost function 20 approximates the cost effects of an incremental change in a value set between a parent chromosome and a child chromosome, and subtracts the cost effects from the cost determined for the parent chromosome to provide an approximate cost for the child chromosome. The speculative costs can be approximated for one or more first generation speculative children chromosomes in a similar manner.

The genetic algorithm 20 can generate a second generation of speculative children from the first generation speculative children in the speculative pool 22, which become speculative parents of the second generation. The second generation speculative parents can be selected based on minimum costs associated with the plurality of first generation speculative chromosomes residing in the speculative pool 22.

The incremental cost function 20 employs the second generation speculative parents selected from the first generation speculative chromosomes, the second generation speculative child chromosome generated from the second generation speculative parents, and the cost-evaluation of the second generation speculative parents to approximate a speculative cost for the second generation speculative child chromosome. This is repeated for each speculative children chromosomes of the second generation. The genetic algorithm 20 can then generate a third generation of speculative chromosomes from parents selected from the second generation speculative chromosomes residing in the speculative pool 22, and the incremental cost function 20 can determine speculative costs associated with the third generation speculative chromosomes. This process can be repeated for subsequent generations, until it is decided that validation of the speculative chromosomes is desired.

New speculative children of each generation and associated speculative costs are stored in the speculative pool 22. The new speculative chromosomes with lower speculative costs can replace older speculative chromosomes with higher speculative costs in the speculative pool 22. The new and older speculative chromosomes can be ranked or ordered in the speculative pool 22 based on minimal costs, so that new speculative chromosome parents and/or real parents with lower costs can be selected for the next generation. This process is repeated for subsequent generations of speculative chromosomes, until it is decided that validation of the speculative chromosomes is desired.

Validation of the speculative chromosomes is accomplished by executing the real cost function 14 on the speculative chromosomes to generate real costs associated with the speculative chromosomes. The speculative chromosomes then become real chromosomes with associated real costs. The new real chromosomes and associated real costs are added to the real pool 16. The new real chromosomes with lower real costs can replace older real chromosomes with higher real costs in the real pool 16. The new and older real chromosomes can be ranked based on minimal costs, so that real chromosomes with the minimal real costs reside in the real pool 16. Validation of the speculative chromosomes may be initiated in many ways, examples of which may be based on the number of speculative generations, speculative costs converging or when a predetermined error level has been exceeded. It is to be appreciated that the inherent error of the incremental cost function 20 may increase with each generation of speculative chromosomes, since approximate cost might be based on previous approximations.

The real pool 16 can be evaluated to determine if a desirable solution has been achieved. The desirable solution can be based on achieving a minimum cost associated with a real chromosome or when real costs converge. If the desirable solution has not been achieved, a new incremental cost function can be generated based on a new set of real chromosomes and real costs. The process of generating new generations of speculative chromosomes via the genetic algorithm 18 and speculative costs based on the new incremental cost function can be repeated. The new generations of speculative chromosomes in the speculative pool 22 can be employed to update the real chromosomes. This process repeats until a desirable solution or value set based on the real cost function 14 resides in the real pool 16.

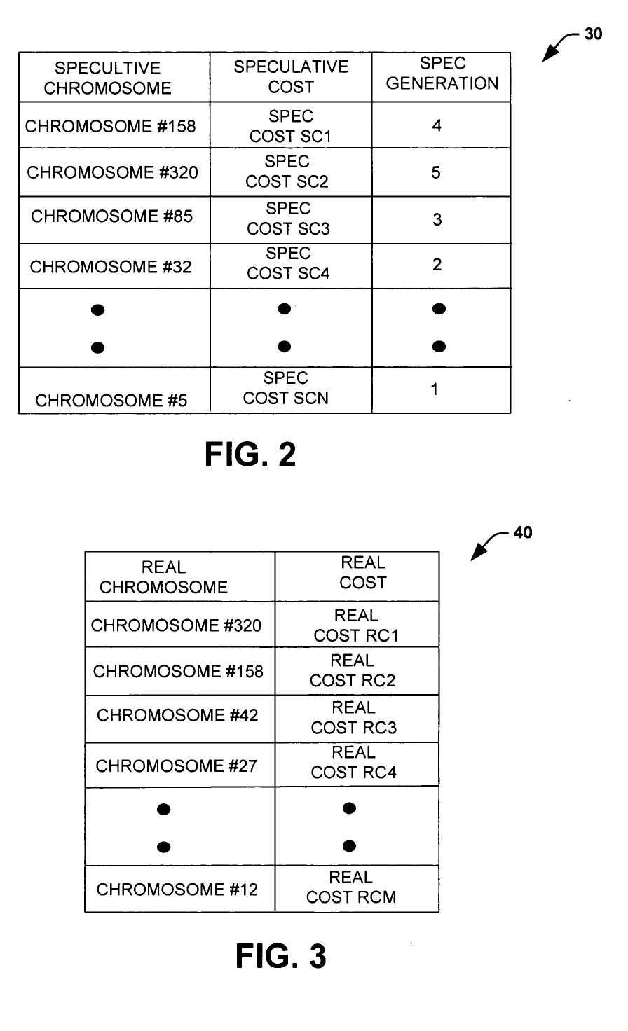

FIG. 2 illustrates an exemplary speculative pool 30. The exemplary speculative pool 30 includes a first column that identifies speculative chromosomes (e.g., by chromosome numbers), a second column that lists speculative costs associated with the corresponding speculative chromosomes, and a third column that lists speculative generation count associated with the speculative chromosomes number. The speculative chromosome number corresponds to a particular value set stored in memory that identifies a value set represented by a given chromosome. The speculative chromosome number can be a label, reference, and/or pointer to the value set associated with the speculative chromosome. The speculative generation count refers to which generation of speculation the speculative chromosome corresponds.

For example, speculative chromosomes derived from real parents are first generation speculative chromosomes. Speculative chromosomes derived from first generation speculative chromosome parents are second generation speculative chromosomes. Speculative chromosomes derived from second generation speculative chromosome parents are third generation speculative chromosomes, etc. Furthermore, speculative chromosomes derived from real and speculative parents are assigned a generation above the speculative parent.

Each generation of speculative chromosomes and associated speculative costs are compared with the current population of speculative chromosomes. Speculative chromosomes with lower costs replace speculative chromosomes with higher speculative costs in the speculative pool 30, such that N number of speculative chromosomes are retained in the speculative pool 30, where N is an integer greater than one. The speculative chromosomes can be ranked based on minimum speculative costs (SC1-SCN), where SC1 is less than SCN. The entire speculative pool can be assigned a cost SC1, which corresponds to the speculative chromosome with the minimum speculative cost in the speculative pool 30. It is to be appreciated that the speculative chromosomes can be ranked based on other criteria in addition to speculative costs.

One or more of the speculative chromosomes can be validated by executing a real cost function on the one or more speculative chromosomes. Once a speculative chromosome is validated, the speculative chromosome can be removed from the speculative pool and added to the real pool. Alternatively, the entire speculative pool 30 can be validated removing the speculative pool from memory. A new speculative pool can be generated based on a new incremental cost function and new real chromosomes.

FIG. 3 illustrates an exemplary real pool 40. The exemplary real pool 40 includes a first column that identifies real chromosome numbers and a second column that identifies real costs associated with the corresponding real chromosome number. The real chromosome number corresponds to a particular value set stored in memory. The real chromosome number can be a label, reference, and/or pointer to the value set associated with the real chromosome. Validated speculative chromosomes are converted to new real chromosomes with associated real costs. The real costs associated with the new real chromosomes are compared with the current population of real chromosomes.

Real chromosomes with lower costs can replace real chromosomes with higher real costs in the real pool, such that M number of real chromosomes are retained in the real pool, where M is an integer greater than one. The entire real pool 40 can be assigned a cost RC1, which corresponds to the real chromosome with the minimum real cost in the real pool 40. The number of retained real chromosomes M in the real pool 40 can be equal or not equal to the number of retained chromosomes N in the speculative pool 30. The employment of separate speculative pools and real pools helps assure that speculative chromosomes and its associated speculative costs do not replace at least a substantial portion of the real costs and the real chromosomes if both were kept in similar pools. The validated speculative chromosomes in the real pool 40 have the same identifying number as the speculative chromosomes in the speculative pool 30. However, new identifying numbers can be assigned to validated speculative chromosomes added to the real pool 40.

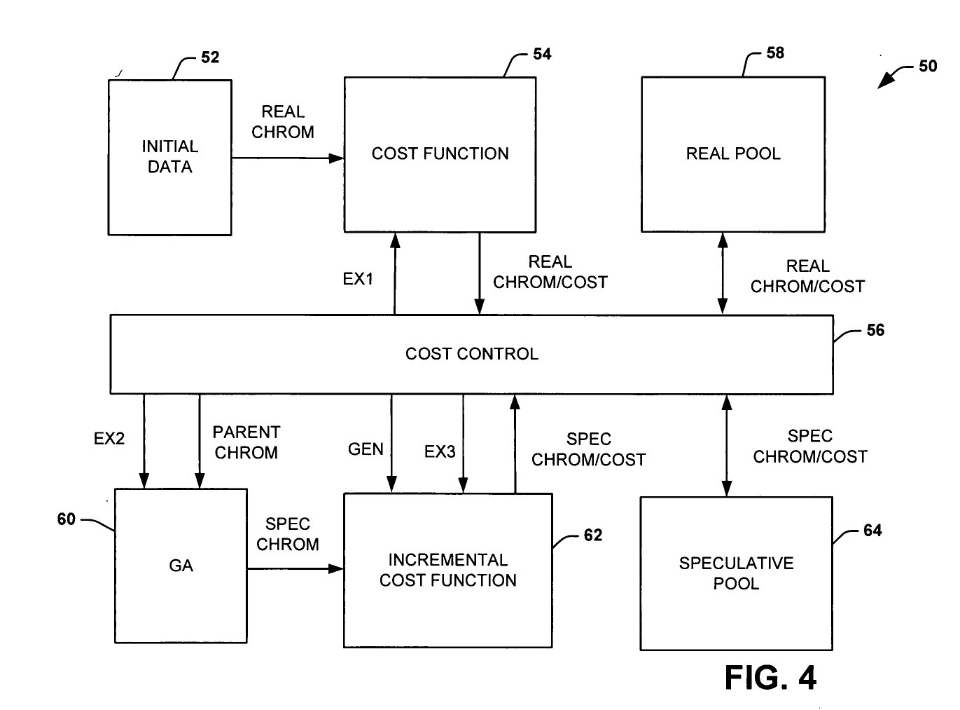

FIG. 4 illustrates an alternate system 50 for selecting a value set associated with a set of parameters. Each value set is represented as a chromosome, which may be a real chromosome or a speculative chromosome. A real chromosome is employed by a non-incremental or real cost function 54 to generate a real cost, and a speculative chromosome is employed by an incremental cost function 62 to generate a speculative cost. A speculative cost is an approximate cost that is based on an incremental change in a chromosome (e.g., incremental change in value of one or more parameters) and an approximation of a cost difference between the cost associated with a parent chromosome (e.g., mother chromosome, father chromosome), and a child chromosome.

A cost control component 56 executes (EX1) a non-incremental or real cost function 54. The non-incremental or real cost function 54 determines a set of real costs associated with an initial set of data or real chromosomes 52. The cost control component 54 sorts (e.g., ranks, orders) the real chromosomes and associated real costs and stores them in a real pool 58. It is to be appreciated that the real pool 58 can contain references, for example pointers, to the value sets associated with the real chromosomes. The cost control component 56 then generates (GEN) an incremental cost function 62. The incremental cost function 62 can be generated based on the real chromosomes residing in the real pool 58, and a minimum real cost assigned to the real pool 58. The minimum real cost assigned to the real pool 58 can be based on the real chromosome with the lowest cost in the real pool 58.

The cost control component 56 invokes execution (EX2) of a genetic algorithm 60. The cost control component 56 provides parent chromosomes selected from the real pool 58 to the genetic algorithm 60. The genetic algorithm 40 generates speculative children chromosomes through a process of crossover and mutation of parent chromosomes selected from the real pool 58. The children chromosomes derived from parents of the real chromosomes are a first generation of speculative chromosomes. The first generation speculative chromosomes are provided to the incremental cost function 62. The incremental cost function 62 generates speculative costs associated with the first generation speculative chromosomes. The speculative costs are approximations of the real costs associated with the first generation speculative chromosomes. The incremental cost function 62 determines an incremental difference between the value sets of the real chromosome parents and the value sets of the speculative chromosome children. The incremental difference and the real cost associated with the real parent chromosomes is employed to provide a speculative cost or approximate cost associated with speculative children chromosomes.

The cost control component 56 sorts, ranks, and/or orders the speculative chromosomes based on associated minimum speculative costs, and stores the speculative chromosomes in a speculative pool 64. The cost control component 56 then selects speculative chromosomes from the speculative pool 64 to become parents. Alternatively, parents can be selected from the speculative pool 64 and the real pool 58, such that one parent is selected from the speculative pool 64 and another parent is selected from the real pool 58 for a given child chromosome. The selected parent chromosomes are employed by the genetic algorithm 60 to produce a second generation of speculative children chromosomes. The selected parent chromosomes can be selected based on minimum speculative and/or real costs. Alternatively, multiple combinations of speculative and/or real parents can be selected to generate various second generation speculative chromosomes from first generation speculative chromosomes residing in the speculative pool 64 and/or real parents residing in the real pool 58.

The genetic algorithm 60 generates second generation speculative children chromosomes through a process of crossover and mutation of parent chromosomes. The second generation speculative chromosomes are provided to the incremental cost function 62. The incremental cost function 62 determines an incremental difference between the value sets of the selected parents and the value sets of the second generation speculative chromosome children. The incremental cost function 62 determines a speculative cost for the second generation speculative chromosome children employing the incremental differences and the speculative cost associated with at least one of the chromosome parents. The second generation speculative chromosomes and associated speculative costs are added to the speculative pool 64 by replacing speculative chromosomes with higher speculative costs. The process of selecting parent chromosomes, generating speculative children chromosomes and determining speculative costs with the new parent chromosomes can be repeated for P generations, where P is a positive integer.

The cost control component 56 initiates a validation on speculative chromosomes in the speculative pool 64. A validation comprises executing the non-incremental or real cost function 54 on one or more speculative chromosomes to generate real costs associated with the one or more speculative chromosomes. The speculative chromosomes then become real chromosomes, which are added to the real pool 58 with their associated real costs. The new set of real chromosomes and real costs associated with validated speculative chromosomes are added to the real pool 58 with lower cost real chromosomes replacing higher cost real chromosomes.

It is appreciated that a variety of different criteria can be employed to determine when to initiate a validation. Validation of the speculative chromosomes may be initiated in many ways, examples of which may be based on the number of speculative generations, speculative costs converging or when a predetermined error level has been exceeded. It is to be appreciated that the inherent error of the incremental cost function 62 may increase with each generation of speculative chromosomes, since approximate cost might be based on previous approximations.

The cost control function 58 analyzes the real pool to determine if a desirable solution exists. If a desirable solution has not been achieved, a new incremental cost function is generated based on a new selected set of real chromosomes from the real pool 58. Additional generations of speculative chromosomes and speculative costs are generated based on the new incremental cost function, until a validation is initiated. The process of validating, generating new incremental cost functions, new speculative generations and associated speculative costs are repeated until a desirable solution has been achieved.

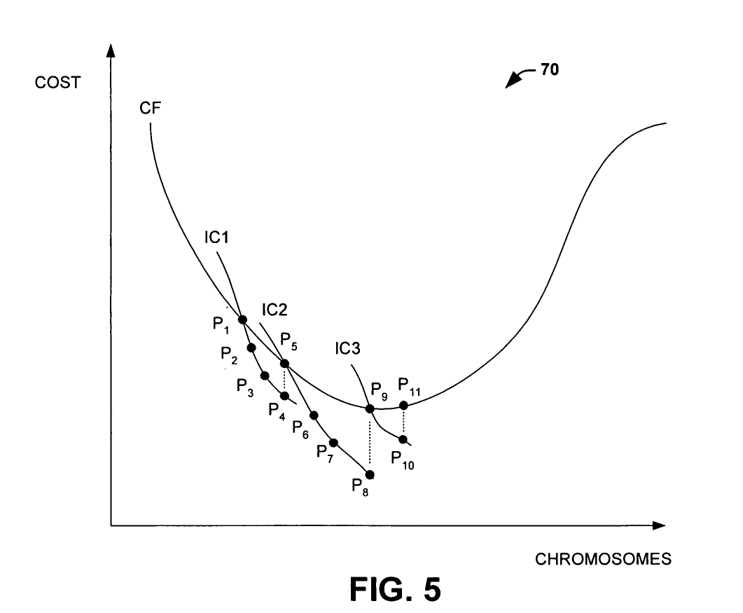

FIG. 5 is a graph 70 that illustrates a relationship between an exemplary real cost function (CF) and a plurality of incremental cost functions (IC1-IC3). The graph 70 illustrates the real cost function (CF) and the plurality of incremental cost functions (CF) in two dimensions. However, it is to be appreciated that a multi-variable cost function will have as many dimensions as variables or parameters in the cost function. For example, a k variable cost function has k dimensions, were k is an integer greater than one. The number of variables and associated dimensions map to a single cost value. The graph 70 illustrates costs versus chromosomes sets.

As illustrated in the graph 70, a first real pool P1, corresponding to a pool of real chromosomes and an associated real cost resides on the cost function CF. A real pool is assigned a real cost based on the minimum cost chromosome associated with the real pool. This allows mapping of an entire pool to a single cost. A first incremental cost function (IC1) is generated beginning with the real pool P1 and its assigned real cost. A genetic algorithm employs one or more real chromosomes as parents selected from the real pool P1 to generate a set of speculative chromosomes. The incremental cost function IC1 provides associated speculative costs to the set of speculative chromosomes. The set of speculative chromosomes and associated speculative costs are ranked and stored in a speculative pool P2. The speculative pool P2 is assigned a speculative cost determined by the incremental cost function IC1 that is based on the minimum cost chromosome associated with the speculative pool P2.

The speculative pool P2 is employed to generate a new generation of speculative chromosomes and associated speculative costs. A genetic algorithm employs one or more speculative chromosomes as parents selected from the speculative pool P2 to generate a set of speculative children chromosomes. Alternatively, parents can be selected from the real pool P1 and the speculative pool P2. The incremental cost function IC1 provides associated speculative costs to the set of speculative children chromosomes. The speculative children chromosomes replace speculative parent chromosomes with higher costs, such that a new speculative pool P3 is formed with a lower cost. If none of the speculative chromosomes have lower costs, then the speculative parents can be validated by executing the real cost function CF1 on one or more members of the speculative pool P2. Alternatively, a new incremental cost function can be selected to achieve better results. The speculative pool P3 is assigned a speculative cost based on the minimum cost chromosome associated with the speculative pool P3.

A genetic algorithm employs one or more speculative chromosomes as parents selected from the speculative pool P3 to generate a set of speculative children chromosomes. Alternatively, parents can be selected from the real pool P1 and the speculative pools P2 and P3. The incremental cost function IC1 provides associated speculative costs to the set of speculative children chromosomes. The speculative children chromosomes replace speculative parent chromosomes with higher costs, such that a new speculative pool P4 is formed with a lower cost. A validation is initiated on the speculative chromosomes residing in the speculative pool P4, where one or more speculative chromosomes of the speculative pool P4 are provided to the real cost function CF. A new set of real chromosomes and real costs are generated. The new set of real chromosomes and real costs are combined with the real pool P1 with lower cost chromosomes replacing higher cost chromosomes, such that a new real pool P5 is generated, and moved to the real cost function CF.

A second incremental cost function (IC2) is generated beginning with the real pool P5 and its assigned real cost. A genetic algorithm employs one or more real chromosomes as parents selected from the real pool P5 to generate a set of speculative chromosomes. The incremental cost function IC2 provides associated speculative costs to the set of speculative chromosomes. The set of speculative chromosomes and associated speculative costs are ranked and stored in a speculative pool P6. The speculative pool P6 is assigned a speculative cost determined by the incremental cost function IC2 that is based on the minimum cost chromosome associated with the speculative pool P6.

The speculative pool P6 is employed to generate a new generation of speculative chromosomes and associated speculative costs. Alternatively, parents can be selected from the real pool P5 and the speculative pool P6. A genetic algorithm generates a set of speculative children chromosomes from the selected parents. The incremental cost function IC2 provides associated speculative costs to the set of speculative children chromosomes. The speculative children chromosomes replace speculative parent chromosomes with higher costs, such that a new speculative pool P7 is formed with a lower cost. The speculative pool P7 is assigned a speculative cost based on the minimum cost chromosome associated with the speculative pool P7.

The speculative pool P7 is employed to generate a new generation of speculative chromosomes and associated speculative costs. Alternatively, parents can be selected from the real pool P5 and the speculative pools P6 and P7. A genetic algorithm employs the selected parents to generate a new generation of speculative children chromosomes. The incremental cost function IC2 provides associated speculative costs to the new generation of speculative children chromosomes. The speculative children chromosomes replace speculative parent chromosomes with higher costs, such that a new speculative pool P8 is formed with a lower cost.

A validation is initiated on the speculative chromosomes residing in the speculative pool P8, where one or more speculative chromosomes of the speculative pool P8 are provided to the real cost function (CF). A new set of real chromosomes and real costs are generated. The new set of real chromosomes and real costs are combined with the real pool P5 with lower cost chromosomes replacing higher cost chromosomes, such that a new real pool P9 is generated.

The set of real chromosomes in the pool P9 are employed to generate a third incremental cost function (IC3). The set of real chromosomes in real pool P9 and associated costs are employed to generate a set of speculative chromosomes and associated speculative costs stored in a speculative pool P10. A validation is initiated on the speculative pool P10 where one or more speculative chromosomes of the speculative pool P10 is provided to the cost function (CF). A new set of real chromosomes and real costs are generated. The new set of real chromosomes and real costs are combined with the real pool P9 with lower cost chromosomes replacing higher cost chromosomes, such that a new real pool P11 is generated.

It is determined that the minimal cost assigned to the real pool P11 is higher than the minimal cost assigned to the real pool P9. Therefore, the real pool P9 offers a better solution than P11. A minimal cost real chromosome is selected from the real chromosomes represented at P9 as a desirable solution. The selection routine then terminates. It is to be appreciated that more or less than three incremental cost functions can be generated to determine a desirable solution associated with the real cost function (CF).

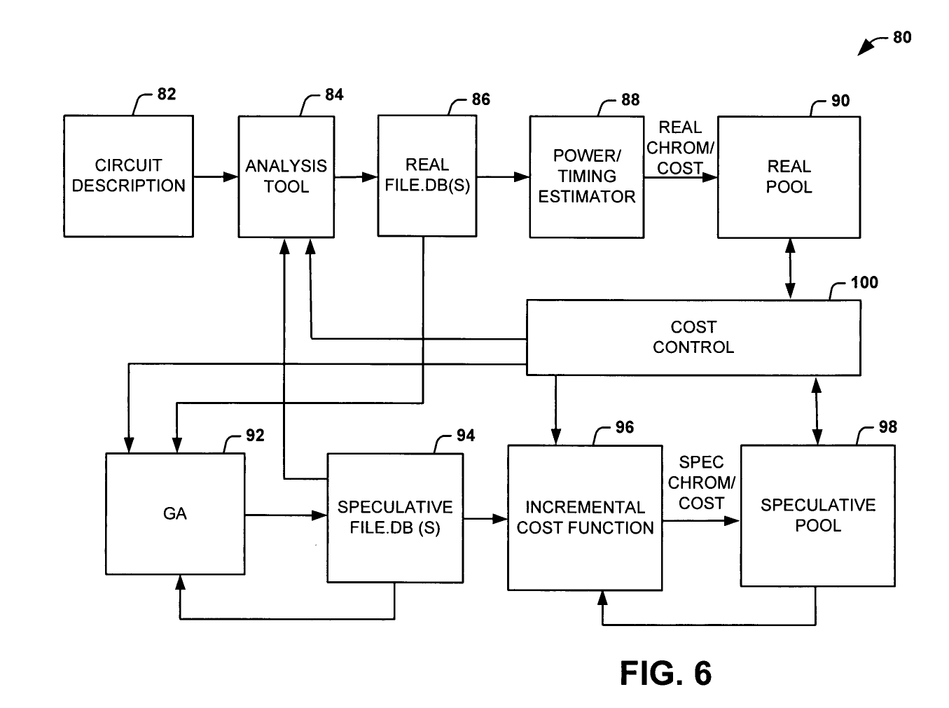

FIG. 6 illustrates a system 80 for optimizing a circuit design. The system 80 employs a circuit design description 82 to provide information to an analysis tool 84. The design description 82 can include transistor netlists, design netlists, design parasitic data and timing constraints associated with the circuit design. The analysis tool 84 executes a device modification and timing algorithm to optimize a circuit design. For example, the analysis tool 82 can be a static timing analysis tool (e.g., PATHMILL® by Synopsys) for block and chip timing verification. A static timing analysis tool will generate a plurality of circuit design configurations that correspond to device changes (e.g., transistor sizing, cell device modifications) based on timing and delay analysis to optimize the circuit design based on speed, power and area. Alternatively, the analysis tool 84 can be a transistor autosizer (e.g., AMPS® by Synopsys). Most transistor autosizers rely on heuristic approaches that focus on finding the best combination that will meet user-defined power and speed goals without changing the functionality of the design. The transistor autosizers employ an original circuit design description to generate a plurality of circuit sizing configurations that define different optimized cell netlist configurations.

The analysis tool 84 performs timing analysis, transistor sizing optimization, device modifications and/or power analysis on the circuit design description 82. The analysis tool 84 executes timing analysis and modifies transistor sizes and/or circuit cell configurations to optimize the circuit design without disturbing the functionality associated with the circuit design. A cost control component 100 invokes the analysis tool 84. The analysis tool 84 then generates one or more real file data bases 86 (File.DB(s)). Each of the one or more real file data bases 86 defines a circuit configuration, and a potential circuit design solution. Each circuit configuration or real file data base 86 is represented as a real chromosome. Any change in the circuit design parameter values (e.g., device width, device length, circuit types, cell types) defines a new real chromosome associated with the circuit design.

The information associated with the one or more real file data bases 86 is provided to a power/timing estimator 88 that generates a real cost, as a function of power and timing characteristics, associated with each real chromosome. The analysis tool 84 and the power/timing estimator 88 cooperate to define a real cost function associated with optimization of the circuit design. The real chromosomes and associated real costs are stored in a real pool 90. The cost control component 100 sorts the real chromosomes and associated real costs based on minimum costs and stores them in the real pool 90. It is to be appreciated that the real pool 90 can contain references, for example pointers, to the real file data bases 86 associated with the real chromosomes, such that the real chromosomes represent real file data bases 86.

The cost control component 100 then generates (GEN) an incremental cost function 96. The incremental cost function 96 can be generated based on the real chromosomes residing in the real pool 90, and a minimum real cost assigned to the real pool 90. The minimum real cost assigned to the real pool 90 can be based on the real chromosome with the lowest cost in the real pool 90.

The cost control component 100 selects parent chromosomes from the real pool 90, and extracts the real file data bases 86 associated with the real chromosomes. One or more real file data bases 86 are provided to a genetic algorithm 92. The genetic algorithm 92 generates a first generation of speculative chromosomes in the form of speculative file data bases 94 (File.DB(s)) through a process of crossover and mutation of parent chromosomes selected from the real file data bases 86. The speculative file data bases 94 are provided to the incremental cost function 96, which determines speculative costs associated with a respective speculative file database 94.

The incremental cost function 96 employs the incremental difference between parent chromosomes having real file data bases 86 and speculative child chromosomes having speculative file data bases 94. The incremental difference and the real cost associated with the real parent file data bases 86 is employed to provide a speculative cost associated with each speculative child chromosome or speculative file data base 94. For example, a change in a circuit design parameter value, such as gate width can be made to generate a speculative file data base from one or more real file databases. An estimated change in power can be determined based on the gate width change. The estimated change in power and the power computed by the power timing/estimator 88 for the real file data base 86 can be employed to determine an approximate power associated with the speculative file data base 94. The speculative chromosomes and associated speculative costs are ranked and stored in a speculative pool 98 via the cost control component 100.

Parent chromosomes are then selected from the speculative pool 98, such that speculative chromosomes become parents of a second generation of speculative chromosomes. Alternatively, parents can be selected from the speculative pool 98 and the real pool 90, such that one parent is selected from the speculative pool 98 and another parent is selected from the real pool 90 for a given child chromosome. The speculative file data bases 94 are employed by the genetic algorithm 92 to produce a subsequent generation of speculative file data bases. The speculative and/or real parent chromosomes can be selected based on minimum speculative costs. Alternatively, multiple combinations of speculative parents and/or real parents can be selected to generate various second generation children chromosomes.

The second generation speculative file data bases 94 are provided to the incremental cost function 96. The incremental cost function 96 employs the incremental difference of circuit design configuration associated with the first generation speculative file data bases and the second generation speculative file data bases. The incremental difference and the speculative cost associated with the first generation speculative chromosome parents are employed to provide a speculative cost associated with each second generation speculative child chromosomes. This process can then be repeated for subsequent generations (e.g., 3^{rd} generation, 4^{th} generation, etc.) of speculative file data bases employing parents of a previous generation.

The second generation speculative chromosomes and associated speculative costs are added to the speculative pool 98 by replacing speculative chromosomes with higher speculative costs. The process of selecting speculative parent chromosomes, generating speculative children chromosomes and determining speculative costs with the new parent chromosomes can be repeated for Q generations, where Q is a positive integer.

Errors increase with each generation of speculation for a given cost function. Validation of the speculative file data bases 94 can be initiated when a predetermined number of generations has been generated, when speculative costs 98 associated with new generations has reached a minimum or converges, or when a predetermined error level has been achieved. It is appreciated that a variety of different criteria can be employed to determine when to initiate a validation. During validation, the speculative file data bases 94 stored in the speculative pool 98 are provided to the analysis tool 84. The analysis tool 84 then executes the parameter values associated with the speculative file data bases 94 to generate real file data bases 86 associated with the circuit design configurations. The power/timing estimator 88 then generates real costs associated with the new real file data bases 84.

The new set of real file data bases 86 and real costs 90 are added to the real pool 90 with lower cost real chromosomes replacing higher cost real chromosomes. The cost control component reorders the real pool and discards higher cost real chromosomes for lower cost real chromosomes. The real pool is then analyzed to determine if an optimal solution exists. If an optimal solution has not been achieved, the new set of real file data bases 86 stored in the real pool 90 are employed as parent chromosomes to generate additional generations of speculative chromosomes and speculative costs via a new incremental cost function. The process of validating, generating new incremental cost functions, new speculative generations and associated speculative costs are repeated until an optimal circuit design has been achieved.

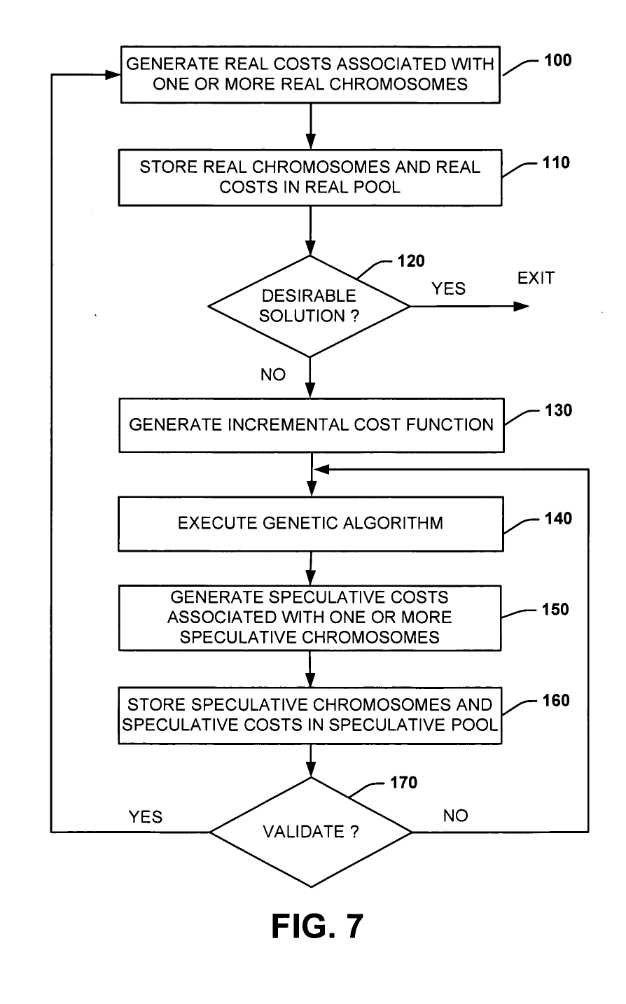

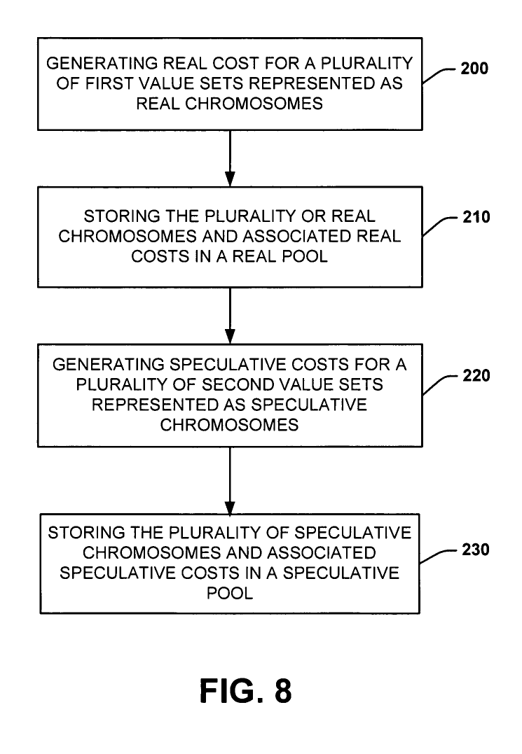

In view of the foregoing structural and functional features described above, certain methodologies that can be implemented will be better appreciated with reference to FIGS. 7-8. While, for purposes of simplicity of explanation, the methodologies of FIGS. 7-8 are shown and described as being implemented serially, it is to be understood and appreciated that the illustrated actions, in other embodiments, may occur in different orders and/or concurrently with other actions. Moreover, not all illustrated features may be required to implement a methodology. It is to be further understood that the following methodologies can be implemented in hardware, software (e.g., computer executable instructions), or any combination thereof.

It is to be further understood that the following methodology can be implemented in hardware, software, or any combination thereof. For example, in one embodiment the methodologies can be implemented as computer executable instructions, such as can be stored in a desired storage medium (e.g., random access memory, a hard disk drive, CD ROM, and the like). In another embodiment, a methodology can be implemented as computer executable instructions running on a computer or design tool.

FIG. 7 illustrates a methodology for optimizing a value set associated with a set of parameters. At 100, a real cost function is executed on one or more value sets associated with a set of parameters. Each value set represents a real chromosome with each parameter value representing a gene associated with the real chromosome. For example, the set of parameters can be parameters (e.g., device width, device length, circuit types, cell types) associated with a circuit design. The real cost function generates real costs for each of the one or more real chromosomes that represent one or more value sets associated with a set of parameters. At 110, the real chromosomes and real costs are stored in a real pool. The real chromosomes and real costs can be sorted based on minimum real costs associated with a given chromosome. At 120, it is determined if a desirable solution has been obtained by analyzing the costs associated with the real chromosomes in the real pool. If a desirable solution has been achieved (YES), the methodology terminates or exits. If a desirable solution has not been achieved (NO), the methodology proceeds to 130.

At 130, an incremental cost function is generated based on the real chromosomes in the real pool and an associated minimum real cost assigned to the real pool. The minimum real cost assigned to the real pool can be based on the real chromosome with the lowest cost in the real pool. At 140, a genetic algorithm is executed to generate at least one speculative chromosome. A speculative chromosome is an incremental modification of a value set associated with one or more parent chromosomes. The parent chromosomes can be real or speculative. At 150, the incremental cost function is executed to generate speculative costs associated with one or more speculative chromosomes. At 160, the speculative chromosomes and associated speculative costs are stored in the speculative pool.

At 170, the methodology determines whether to validate the speculative chromosomes or to generate additional generations. If the methodology determines a validation is desired (YES), the methodology returns to 100. A validation comprises executing the real cost function on one or more speculative chromosomes to generate real costs associated with the one or more speculative chromosomes, thus adding the one or more speculative chromosomes to the set of real chromosomes. The real chromosomes and associated new costs are added to the real pool at 110, such that new real chromosomes having lower costs replace older real chromosomes having higher real costs. Validation of the speculative chromosomes can be initiated when a predetermined number of generations has been generated, when speculative costs associated with new generations has reach a minimum or converges, or when a predetermined error level has been exceeded. It is appreciated that a variety of different criteria can be employed to determine when to initiate a validation.

If the methodology determines a validation is not desired (NO), the methodology returns to 140 to generate a new generation of speculative chromosomes and speculative costs at 150. The new generation of speculative chromosomes and associated speculative costs is added to the speculative pool at 160, such that new speculative chromosomes having lower speculative costs replace speculative chromosomes having speculative real costs. The methodology then proceeds to 170 to determine if a validation has been initiated.

FIG. 8 illustrates an alternate methodology for selecting a value set associated with a set of parameters. At 200, real costs are generated for a plurality of first value sets represented as real chromosomes. At 210, the plurality of real chromosomes and associated real costs are stored in a real pool. The methodology then proceeds to 220. At 220, speculative costs are generated for a plurality of second value sets represented as speculative chromosomes. At 230, the plurality of speculative chromosomes and associated speculative costs are stored in a speculative pool.

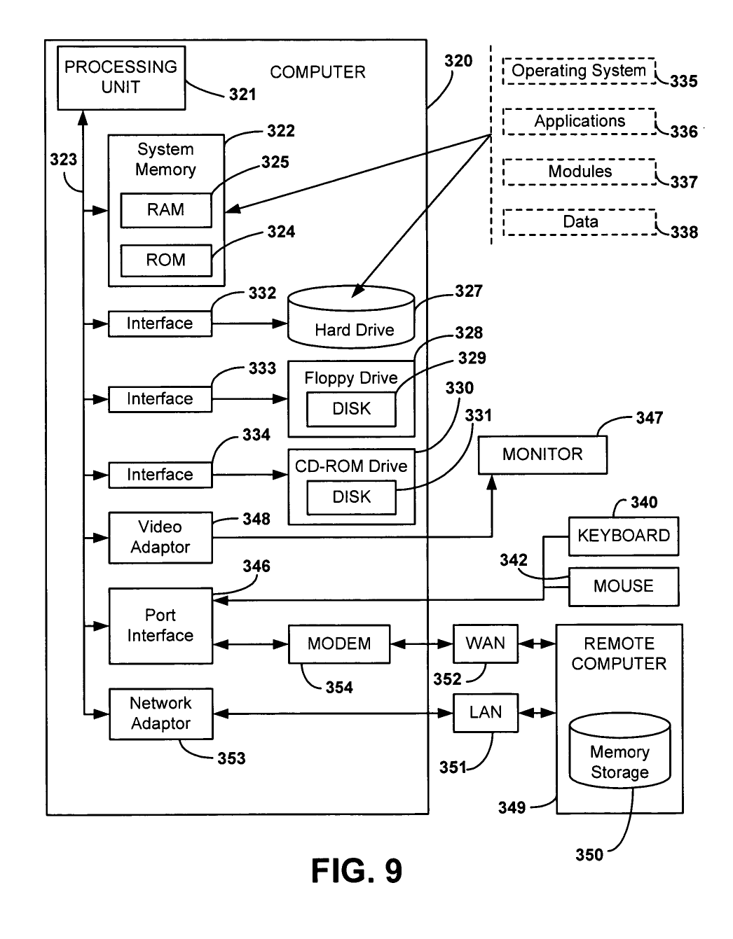

FIG. 9 illustrates a computer system 320 that can be employed to execute one or more embodiments employing computer executable instructions. The computer system 320 can be implemented on one or more general purpose networked computer systems, embedded computer systems, routers, switches, server devices, client devices, various intermediate devices/nodes and/or stand alone computer systems. Additionally, the computer system 320 can be implemented on various mobile clients such as, for example, a cell phone, personal digital assistant (PDA), laptop computer, pager, and the like.

The computer system 320 includes a processing unit 321, a system memory 322, and a system bus 323 that couples various system components including the system memory to the processing unit 321. Dual microprocessors and other multi-processor architectures also can be used as the processing unit 321. The system bus may be any of several types of bus structure including a memory bus or memory controller, a peripheral bus, and a local bus using any of a variety of bus architectures. The system memory includes read only memory (ROM) 324 and random access memory (RAM) 325. A basic input/output system (BIOS) can reside in memory containing the basic routines that help to transfer information between elements within the computer system 320.

The computer system 320 can includes a hard disk drive 327, a magnetic disk drive 328, e.g., to read from or write to a removable disk 329, and an optical disk drive 330, e.g., for reading a CD-ROM disk 331 or to read from or write to other optical media. The hard disk drive 327, magnetic disk drive 328, and optical disk drive 330 are connected to the system bus 323 by a hard disk drive interface 332, a magnetic disk drive interface 333, and an optical drive interface 334, respectively. The drives and their associated computer-readable media provide nonvolatile storage of data, data structures, and computer-executable instructions for the computer system 320. Although the description of computer-readable media above refers to a hard disk, a removable magnetic disk and a CD, other types of media which are readable by a computer, such as magnetic cassettes, flash memory cards, digital video disks and the like, may also be used in the operating environment, and further that any such media may contain computer-executable instructions.

A number of program modules may be stored in the drives and RAM 325, including an operating system 335, one or more application programs 336, other program modules 337, and program data 338. A user may enter commands and information into the computer system 320 through a keyboard 340 and a pointing device, such as a mouse 342. Other input devices (not shown) may include a microphone, a joystick, a game pad, a scanner, or the like. These and other input devices are often connected to the processing unit 321 through a corresponding port interface 346 that is coupled to the system bus, but may be connected by other interfaces, such as a parallel port, a serial port or a universal serial bus (USB). A monitor 347 or other type of display device is also connected to the system bus 323 via an interface, such as a video adapter 348.

The computer system 320 may operate in a networked environment using logical connections to one or more remote computers, such as a remote client computer 349. The remote computer 349 may be a workstation, a computer system, a router, a peer device or other common network node, and typically includes many or all of the elements described relative to the computer system 320. The logical connections can include a local area network (LAN) 351 and a wide area network (WAN) 352.

When used in a LAN networking environment, the computer system 320 can be connected to the local network 351 through a network interface or adapter 353. When used in a WAN networking environment, the computer system 320 can include a modem 354, or can be connected to a communications server on the LAN. The modem 354, which may be internal or external, is connected to the system bus 323 via the port interface 346. In a networked environment, program modules depicted relative to the computer system 320, or portions thereof, may be stored in the remote memory storage device 350.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system comprising:
a real cost function that generates real costs for each of a plurality of value sets represented as a plurality of real chromosomes;
a real pool that comprises the plurality of real chromosomes and associated real costs;
an incremental cost function that generates a plurality of speculative costs corresponding to a plurality of value set variations of at least one of the plurality of real chromosomes, the plurality of value set variations represented as a plurality of speculative chromosomes; and
a speculative pool that comprises the plurality of speculative chromosomes and associated speculative costs.

2. The system of claim 1, further comprising a genetic algorithm that generates the plurality of speculative chromosomes employing parent chromosomes selected from the real pool.

3. The system of claim 2, the genetic algorithm generates at least one subsequent generation of speculative chromosomes employing parents chromosomes selected from at least one of the real pool and the speculative pool.

4. The system of claim 3, the incremental cost function determines speculative costs for the at least one subsequent generation of speculative chromosomes by employing costs associated with at least one parent chromosome and a difference between value sets of a speculative chromosome and the at least one parent chromosome for at least some of the speculative chromosomes in the at least one subsequent generation.

5. The system of claim 4, further comprising a cost control component that replaces speculative chromosomes in the speculative pool with speculative chromosomes of subsequent generations having lower costs than the speculative chromosomes in the speculative pool.

6. The system of claim 1, further comprising a cost control component that orders the plurality of speculative chromosomes in the speculative pool based on speculative costs.

7. The system of claim 1, further comprising a cost control component that orders the plurality of real chromosomes in the real pool based on real costs.

8. The system of claim 1, further comprising a cost control component that initiates a validation of at least one speculative chromosome of the speculative pool, the validation comprising executing the real cost function on the at least one speculative chromosome to provide a real cost associated with the at least one speculative chromosome and adding the at least one speculative chromosome to the real pool.

9. The system of claim 8, the cost control component replaces real chromosomes in the real pool with validated speculative chromosomes having lower real costs.

10. The system of claim 1, the real pool further comprising references to value sets stored in memory.

11. The system of claim 1, the speculative pool comprising references to value set variations stored in memory, speculative costs associated with the value set variations, and a speculative generation count corresponding to the value set variation.

12. The system of claim 1, the real cost function comprising an optimization tool for optimizing a circuit design, and the plurality of value sets being a plurality of circuit configurations generated by the optimization tool.

13. The system of claim 12, the real pool cost comprises real file data bases generated by the optimization tool, and the speculative pool comprises speculative file data bases generated by a genetic algorithm, the speculative file databases being circuit configuration variations of the real file data bases.

14. The system of claim 1, wherein N number of speculative chromosomes are retained in the speculative pool, where N is an integer greater than one, and M number of real chromosomes are retained in the real pool, where M is an integer greater than one, such that M is one of equal and not equal to N.

15. A computer-readable medium having stored thereon a data structure comprising:
speculative chromosomes that represent value set variations of at least one parent chromosome that represents a value set, the at least one parent chromosome comprising at least one of a real chromosome and a speculative chromosome;
speculative costs associated with a corresponding speculative chromosomes, the speculative cost being determined for a given speculative chromosome based on a cost of the at least one parent chromosome and a value set variation between the speculative chromosome and the at least one parent chromosome; and
speculative generation counts associated with each speculative chromosomes, the speculation generation count being based on a level of speculation from a real chromosome.

16. The data structure of claim 15, the speculative chromosomes comprising references to value set variations stored in memory.

17. The data structure of claim 15, the at least one parent chromosome comprising a first parent selected from one of a speculative chromosome and a real chromosome and a second parent selected from one of a speculative chromosome and a real chromosome.

18. A system for minimizing a cost associated with a set of parameters representing a solution, the system comprising:
means for generating a plurality of real chromosomes representing different value sets associated with a set of parameters;
means for determining real costs associated with a plurality of real chromosomes representing different value sets associated with a set of parameters;
means for maintaining the plurality of real chromosomes and associated real costs;
means for generating a plurality of speculative chromosomes from parent chromosomes selected from at least one of the plurality of speculative chromosomes and the plurality of real chromosomes;
means for determining a speculative cost for a respective speculative chromosome based on a cost of at least one parent chromosome and a difference in value sets of the at least one parent chromosome and the respective speculative chromosome; and
means for maintaining the plurality of speculative chromosomes and associated speculative costs.

19. The system of claim 18, the means for generating speculative chromosomes being operative to generate additional generations of speculative chromosomes from parents selected from the at least one of the plurality of speculative chromosomes and the plurality of real chromosomes.

20. The system of claim 19, the means for maintaining the plurality of speculative chromosomes and associated speculative costs further maintaining the speculative generation counts associated with a speculative chromosomes respective generation.

21. The system of claim 19, further comprising means for replacing speculative chromosome maintained in the means for maintaining the plurality of speculative chromosomes and associated speculative costs with speculative chromosomes of subsequent generations having lower speculative costs than the speculative chromosome being replaced.

22. The system of claim 18, further comprising means for validating at least one speculative chromosome by executing the means for determining a real cost on at least one speculative chromosome.

23. The system of claim 22, further comprising means for replacing a real chromosome maintained in the means for maintaining the plurality of real chromosomes and associated real costs with validated speculative chromosomes having lower real costs than the real chromosomes being replaced.

24. A method for selecting a value set associated with a set of parameters, the method comprising:
generating real costs for each of a plurality of first value sets represented as a plurality of real chromosomes;
storing the plurality of real chromosomes and associated real costs in a real pool;
generating speculative costs for each of a plurality of second value sets represented as a plurality of speculative chromosomes, the speculative chromosomes representing value set variations of the first value sets; and
storing the plurality of speculative chromosomes and associated speculative costs in a speculative pool.

25. The method of claim 24, further comprising executing a genetic algorithm that selects parents from the plurality of real chromosomes to generate the plurality of speculative chromosomes.

26. The method of claim 25, further comprising executing a genetic algorithm that selects parents from at least one of the plurality of real chromosomes and the plurality of speculative chromosomes to generate subsequent generations of speculative chromosomes.

27. The method of claim 26, further comprising replacing speculative chromosomes from the speculative pool with speculative chromosomes from subsequent generations having lower speculative costs.

28. The method of claim 27, further comprising validating at least one speculative chromosome by determining a real cost associated with the at least one speculative chromosome, and replacing the real chromosomes with validated speculative chromosomes having lower real costs.

29. A computer-readable medium having computer-executable instructions for performing the method of claim 24.
